(19) United States
(12) Patent Application Publication
(10) Pub. No.: US 2017/0163949 A1
(43) Pub. Date: Jun. 8, 2017

(54) APPARATUS USING A PROJECTOR, METHOD, AND STORAGE MEDIUM

(71) Applicant: FUJITSU LIMITED, Kawasaki-shi (JP)

(72) Inventor: Genta Suzuki, Kawasaki (JP)

(73) Assignee: FUJITSU LIMITED, Kawasaki-shi (JP)

(21) Appl. No.: 15/290,108

(22) Filed: Oct. 11, 2016

(30) Foreign Application Priority Data
Dec. 7, 2015 (JP) 2015-238420

(51) Int. Cl. H04N 9/31; G06T 7/00; H04N 13/02

(52) U.S. Cl. CPC H04N 9/3185; H04N 13/0203; H04N 9/3182; H04N 9/3188; G06T 7/0044; G06T 2207/10028

(57) ABSTRACT

An apparatus uses a projector including a display surface and projecting an image on a projection surface. The apparatus detects an object region where a target object is captured in a depth image, a value of each pixel in the depth image representing a distance between the target object and a depth sensor, calculates a position of the target object, which is captured at each pixel corresponding to the target object in the object region, in a real space, shifts the calculated position of the target object in the real space to a position on the projection surface, calculates a display region on the display surface of the projector corresponding to the target object by calculating a position on the display surface of the projector corresponding to the shifted position, and displays an image of the target object in the display region on the display surface of the projector.

### CROSS-REFERENCE TO RELATED APPLICATION

This application is based upon and claims the benefit of priority of the prior Japanese Patent Application No. 2015-238420, filed on Dec. 7, 2015, the entire contents of which are incorporated herein by reference.

### FIELD

The embodiments discussed herein are related to an apparatus using a projector, a method, and a storage medium.

### BACKGROUND

In recent years, an operation supporting system using an Augmented Reality (AR) has been proposed. According to the proposed AR supporting system, an instruction video is displayed so as to be overlaid on a moving image of a target of a user operation if the user holds a camera in front of the target. At this time, the AR supporting system appropriately deforms the instruction video and displays the deformed instruction video so as to be overlaid on the moving image captured by the camera in order to match a line of sight of the instruction video with a line of sight of the moving image captured by the camera in accordance with a positional relationship between the camera and the target of the operation.

As an example of related art, Goto et al., “AR-Based Supporting System by Overlay Display of Instruction Video”, The Journal of the Institute of Image Electronics Engineers of Japan, Vol. 39, No. 6, pp. 1108 to 1120, 2010 is known.

### SUMMARY

According to an aspect of the invention, an apparatus using a projector that includes a display surface and projects an image on a projection surface by displaying the image on the display surface, the apparatus includes: a memory; and a processor coupled to the memory and configured to: detect an object region where a target object is captured in a depth image obtained by a depth sensor, a value of each pixel in the depth image representing a distance between the target object and the depth sensor, calculate a position of the target object, which is captured at each pixel corresponding to the target object in the object region, in a real space, shift the calculated position of the target object in the real space to a position on the projection surface, calculate a display region on the display surface of the projector corresponding to the target object by calculating a position on the display surface of the projector corresponding to the shifted position, and display an image of the target object in the display region on the display surface of the projector.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a hardware configuration diagram of a projection apparatus according to a first embodiment;

FIG. 2 illustrates an example of a positional relationship between a depth sensor and a projector of the projection apparatus and a projection surface to which an image of a projection target object is projected according to the first embodiment;

FIG. 3 is a functional block diagram of a control unit according to the first embodiment;

FIG. 4 illustrates a relationship between a depth sensor coordinate system and a world coordinate system;

FIG. 5A illustrates an example of a depth image and a displayed image and a projected image of the projector in a case where the projection target object is located at a position relatively close to the projection surface;

FIG. 5B illustrates an example of a depth image and a displayed image and a projected image of the projector in a case where the projection target object is located at a position relatively far from the projection surface;

FIG. 6 is an operation flowchart of projection processing;

FIG. 7 is a hardware configuration diagram of a projection apparatus according to a second embodiment;

FIG. 8 illustrates an example of a relationship between the respective components of the projection apparatus according to the second embodiment, a surface of a work platform, and an operation target object;

FIG. 9 is a functional block diagram of a control unit according to the second embodiment;

FIG. 10 is an operation flowchart of positioning processing;

FIG. 11 is an operation flowchart of projection processing according to the second embodiment;

FIG. 12A illustrates an example of an image of a projection target object in a case where the height of a projection target object from the surface of the work platform at the time of capturing the image is relatively low in a modification example; and

FIG. 12B illustrates another example of an image of the projection target object in a case where the height of the projection target object from the surface of the work platform at the time of capturing the image is relatively high in a modification example.

### DESCRIPTION OF EMBODIMENTS

In a case where an instruction video is projected to a specific projection surface by using a projector, an image of a projection target object such as a hand of an instructor, a tool, or a component captured in the instruction video may be projected on the projection surface so as to have a larger size than an actual size of the projection target object according to a modification of an instruction video as disclosed in the aforementioned related art document. This is caused by a difference between a distance from a camera that captured the instruction video to the projection target object and a distance from the projector to the projection surface, a difference between a view angle of the camera and a view angle of the projector, or the like. In the case where the image of the projection target object is projected to the projection surface so as to have a larger size than the actual size of the projection target object, a user may erroneously recognize that the size of the projected image of the projection target object is an actual size of the projection target object.

According to an aspect, an embodiment enables a user to visually recognize an actual size of a projection target object when an image of the projection target object captured in advance is projected to a projection surface.

Hereinafter, description will be given of a projection apparatus with reference to drawings. The projection apparatus obtains a position of a projection target object in a real space from a depth image that is obtained by imaging a target object (hereinafter, referred to as a projection target object), an image of which is to be projected by a projector, by a depth sensor capable of measuring a distance to an object positioned in a detection range. The projection apparatus virtually shifts the position of the projection target object in the real space to the projection surface and determines a display region of the image of the projection target object on a display screen of the projector corresponding to the projection target object after the shifting. In doing so, the projection apparatus can project the image of the projection target object so as to have the actual size of the projection target object on the projection surface.

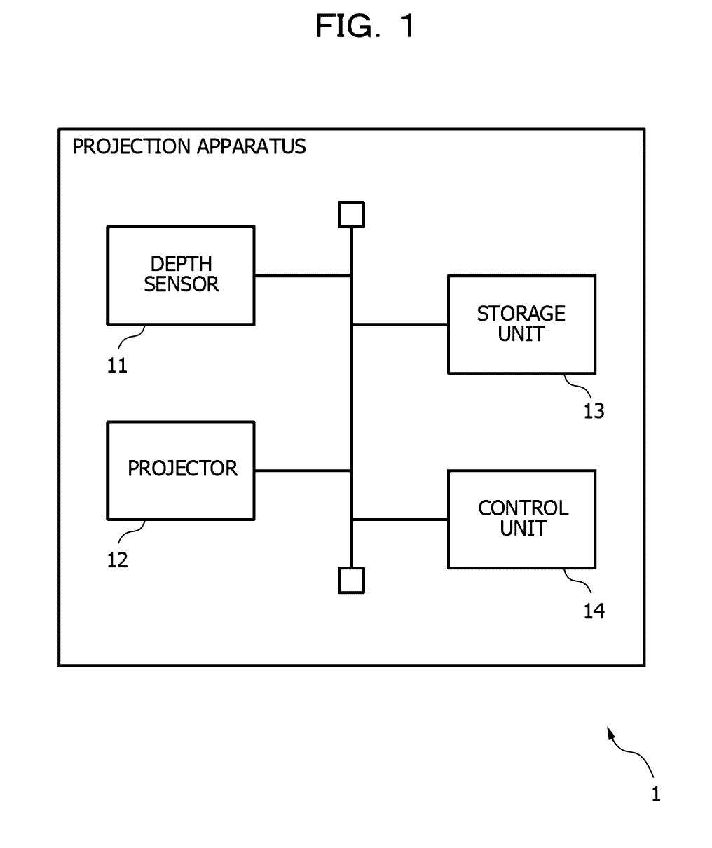

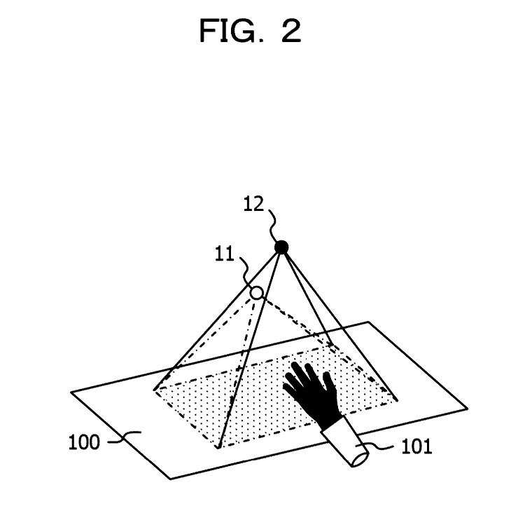

FIG. 1 is a hardware configuration diagram of a projection apparatus according to a first embodiment. FIG. 2 illustrates an example of a positional relationship of a depth sensor and a projector of the projection apparatus and a projection surface to which an image of a projection target object is projected according to the first embodiment. A projection apparatus 1 includes a depth sensor 11, a projector 12, a storage unit 13, and a control unit 14. The depth sensor 11, the projector 12, and the storage unit 13 are respectively coupled to the control unit 14 via signal lines. The projection apparatus 1 may further include a communication interface (not illustrated) for coupling the projection apparatus 1 to other devices.

The depth sensor 11 is an example of a distance measurement unit. The depth sensor 11 is attached so as to be directed toward a projection direction of the projector 12 such that at least a part of a projection surface 100 as a surface of a work platform on which a user performs an operation is included in a detection range, for example, as illustrated in FIG. 2. The depth sensor 11 generates a depth image in the detection range at a specific cycle (30 frames/second to 60 frames/second, for example). Then, the depth sensor 11 outputs the generated depth image to the control unit 14. Therefore, the depth sensor 11 can be a depth camera, for example. In the depth image, a pixel value of each pixel represents a distance from the depth sensor 11 to a point of the projection target object 101 captured at the pixel, for example. As the distance from the depth sensor 11 to the point of the projection target object 101 captured at the pixel in the depth image is shorter, the pixel value becomes larger, for example.

The projector 12 is an example of a projection unit. The projector 12 is installed so as to project a moving image toward the projection surface 100 as illustrated in FIG. 2. Since the projection surface 100 is a surface of the work platform in the embodiment, the projector 12 is attached above the work platform so as to be directed downward in a vertical direction. The projector 12 is a liquid crystal projector, for example. The projector 12 projects the moving image by displaying the moving image on the display surface in accordance with a moving image signal received from the control unit 14. In the embodiment, the projector 12 projects an image of the projection target object 101 to the projection surface 100.

The storage unit 13 includes a volatile or non-volatile semiconductor memory circuit, for example. The storage unit 13 stores the depth image obtained by the depth sensor 11, the moving image signal that represents the moving image projected by the projector 12, and the like. Furthermore, the storage unit 13 stores various kinds of information used in projection processing, such as an installation position and a direction of the depth sensor 11 in a word coordinate system, the number of pixels included in the depth image, and a diagonal view angle of the depth sensor 11. Moreover, the storage unit 13 stores an installation position and a direction of the projector 12 in the world coordinate system, the number of pixels and a diagonal view angle of the display surface, and the like.

The control unit 14 includes one or more processors and a peripheral circuit thereof. The control unit 14 controls the entire projection apparatus 1.

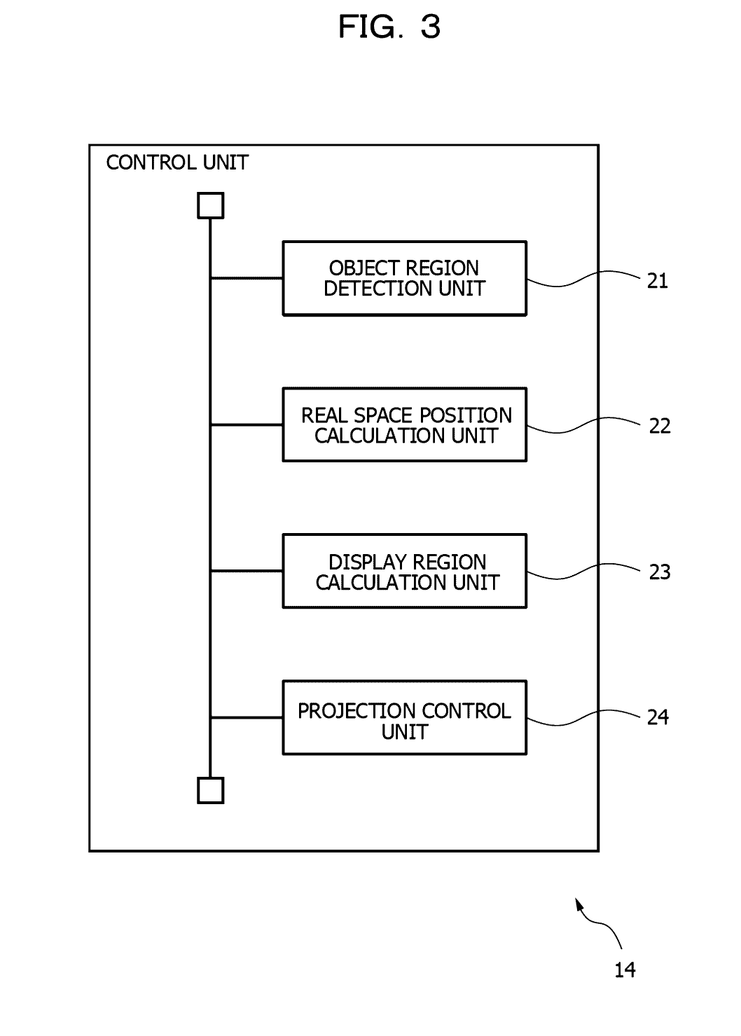

Hereinafter, detailed description will be given of components related to the projection processing that is executed by the control unit 14. FIG. 3 is a functional block diagram of the control unit 14. The control unit 14 includes an object region detection unit 21, a real space position calculation unit 22, a display region calculation unit 23, and a projection control unit 24. These respective components included in the control unit 14 are mounted as functional modules that are realized by computer programs executed by a processor included in the control unit 14, for example. Alternatively, one or more integrated circuits that realize the functions of these respective components may be mounted on the projection apparatus 1 separately from the control unit 14.

In the embodiment, the control unit 14 detects a hand of an instructor as a projection target object from each of a plurality of depth images captured while the instructor executes a series of operations over the projection surface. The control unit 14 determines, for each depth image, a display region of the hand on the display surface of the projector 12 such that the size of the image of the hand is an actual size when the image of the hand detected in the depth image is projected to the projection surface. Then, the control unit 14 sequentially projects, as an instruction video, the images of the hand detected in each of the depth images to the projection surface by the projector 12 in an order of acquisition of the depth images when the instructor instructs the operations to the user. The time when the depth sensor 11 captures an image of the series of operations by the instructor will be simply referred to as time of capturing the image, and the time when projection by the projector 12 is executed will be simply referred to as time of projecting the image in the following description.

In the embodiment, the control unit 14 saves an obtained depth image in the storage unit 13 every time the control unit 14 obtains the depth image from the depth sensor 2 at the time of capturing the image. The control unit 14 executes projection processing on each depth image at the time of projecting the image. Since the control unit 14 can execute the same projection processing on the individual depth images, processing on a single depth image will be described below.

The object region detection unit 21 detects an object region as a region where a projection target object is captured in a depth image obtained by the control unit 14 from the depth sensor 11. For example, the object region detection unit 21 compares, for each pixel on the depth image, a pixel value thereof with a value of a corresponding pixel on a reference depth image obtained in a case where the depth sensor 11 captures the projection surface. The reference depth image is saved in advance in the storage unit 13. The object region detection unit 21 extracts, on the depth image, such pixels that absolute values of differences between the pixel values on the depth image and the corresponding pixel values on the reference depth image are equal to or greater than a predetermined threshold value. The predetermined threshold value can be a pixel value on the depth image corresponding to 1 cm to 2 cm, for example.

The object region detection unit 21 executes labeling processing, for example, on the extracted pixels, groups the extracted pixels, and obtains one or more candidate regions that respectively include extracted pixels and are separate from each other. The object region detection unit 21 sets, as an object region, a candidate region including the maximum number of pixels from among the one or more candidate regions. Since both hands of the instructor are captured in the depth image in some cases, the object region detection unit 21 may set two candidate regions as object regions in an order from the candidate region including a large number of pixels. Alternatively, the object region detection unit 21 may determine that the object region is not included in the depth image, that is, the projection target object is not captured in the depth image in a case where there is no candidate region in which the number of pixels included is equal to or greater than a predetermined number of pixels.

The object region detection unit 21 provides information about the object region on the depth image to the real space position calculation unit 22.

The real space position calculation unit 22 calculates a position of a point of the projection target object, which is captured at each pixel included in the object region, in the real space.

First, the real space position calculation unit 22 calculates a position of the point of the projection target object, which is captured at each pixel included in the object region, in a depth sensor coordinate system. The depth sensor coordinate system is a coordinate system in the real space with reference to the depth sensor 11. Then, the real space position calculation unit 22 converts coordinates of a point of the projection target object corresponding to each pixel in the depth sensor coordinate system into coordinates in the world coordinate system with reference to the projection surface.

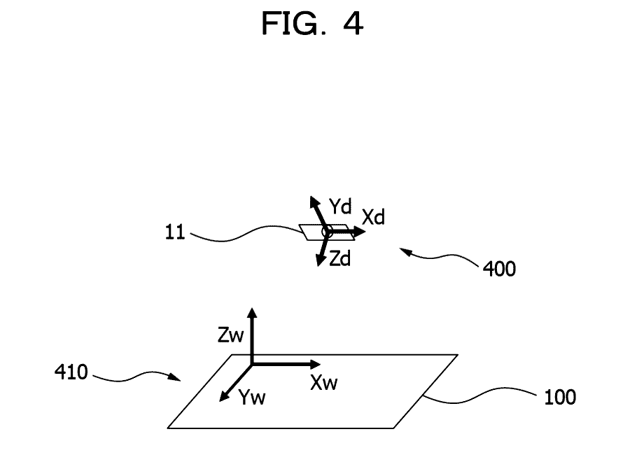

FIG. 4 illustrates a relationship between the depth sensor coordinate system and the world coordinate system. In the depth sensor coordinate system 400, a Zd axis is set in a direction parallel to an optical axis of the depth sensor 11, and an Xd axis and a Yd axis are set so as to orthogonally intersect each other in a plane orthogonally intersecting the Zd axis, that is, a plane parallel to a sensor surface of the depth sensor 11. For example, the Xd axis is set in a direction corresponding to a horizontal direction in the depth image, and the Yd axis is set in a direction corresponding to a vertical direction in the depth image. An origin of the depth sensor coordinate system 400 is set to the center of the sensor surface of the depth sensor 11, that is, a point at which the sensor surface and the optical axis intersect each other.

In contrast, in the world coordinate system 410, two axes, namely an Xw axis and a Yw axis, that orthogonally intersect each other are set on the projection surface 100, and a Zw axis is set so as to be parallel to a normal direction of the projection surface 100. An origin of the world coordinate system 410 is set at one end of a projection range of the projector 12, or the center of the projection range on the projection surface 100, for example. A positional relationship between the depth sensor 11 and the projection surface 100 is known. That is, coordinates of an arbitrary point on the depth sensor coordinate system 400 can be converted to coordinates on the world coordinate system 410 by affine transformation.

The real space position calculation unit 22 calculates coordinates (X_{d}, Y_{d}, Z_{d}) of a point of a projection target object, which is captured at each pixel included in the object region, in the depth sensor coordinate system in accordance with the following Equation.

$${X}_{d} = \frac{{Z}_{d}}{{f}_{d}} \times ( {x}_{d} - \frac{DW}{2} ) \\ {Y}_{d} = \frac{{Z}_{d}}{{f}_{d}} \times ( {y}_{d} - \frac{DH}{2} ) \\ {f}_{d} = \frac{\sqrt{{DW}^{2} + {DH}^{2}}}{2 tan \frac{DFovD}{2}} \qquad ( 1 )$$

Equation (1) is an equation in accordance with a pinhole camera model, where f_{d} represents a focal length of the depth sensor 11, and DW and DH represent the number of pixels in the horizontal direction and the number of pixels in the vertical direction in the depth image, respectively. DFovD represents a diagonal view angle of the depth sensor 11. (x_{d}, y_{d}) represents a position in the horizontal direction and a position in the vertical direction on the depth image. Z_{d} represents a distance between a point of the projection target object at a position corresponding to the pixel (x_{d}, y_{d}) on the depth image and the depth sensor 11 and is calculated based on the value of the pixel (x_{d}, Y_{d}).

Furthermore, the real space position calculation unit 22 converts coordinates of the point of the projection target object, which is captured at each pixel included in the object region, in the depth sensor coordinate system into coordinates (X_{W}, Y_{W}, Z_{W}) in the world coordinate system in accordance with the following equation.

$$( \begin{matrix}{X}_{W} \\ {Y}_{W} \\ {Z}_{W}\end{matrix} ) = {R}_{DW} ( \begin{matrix}{X}_{d} \\ {Y}_{d} \\ {Z}_{d}\end{matrix} ) + {t}_{DW} \\ {R}_{DW} = ( \begin{matrix}1 & 0 & 0 \\ 0 & cos DRotX & - sin DRotX \\ 0 & sin DRotX & cos DRotX\end{matrix} ) ( \begin{matrix}cos DRotY & 0 & sin DRotY \\ 0 & 1 & 0 \\ - sin DRotY & 0 & cos DRotY\end{matrix} ) ( \begin{matrix}cos DRotZ & - sin DRotZ & 0 \\ sin DRotZ & cos DRotZ & 0 \\ 0 & 0 & 1\end{matrix} ) \\ {t}_{DW} = ( \begin{matrix}DLocX \\ DLocY \\ DLocZ\end{matrix} ) \qquad ( 2 )$$

Here, R_{DW} is a rotation matrix representing the amount of rotation included in the affine transformation from the depth sensor coordinate system to the world coordinate system, and t_{Dw} is a parallel movement vector representing the amount of parallel movement included in the affine transformation. DLocX, DLocY, and DLocZ represent coordinates of the center of the sensor surface of the depth sensor 11 in the Xw axis direction, the Yw axis direction, and the Zw axis direction in the world coordinate system, namely coordinates of the origin of the depth sensor coordinate system, respectively. DRotX, DRotY, and DRotZ represent rotation angles of an optical axis direction of the depth sensor 11 with respect to the Xw axis, the Yw axis, and the Zw axis, respectively.

As described above, the real space position calculation unit 22 obtains a range and a position of the projection target object in accordance with the actual size in the real space by calculating the position of the point of the projection target object, which is captured at each pixel included in the object region, in the real space. The real space position calculation unit 22 provides information about the coordinates of each point of the projection target object corresponding to the object region in the world coordinate system to the display region calculation unit 23.

The display region calculation unit 23 calculates a display region that represents a range of the image of the projection target object on the display surface of the projector 12 when the image of the projection target object is projected to the projection surface by the projector 12.

In the embodiment, the projector 12 projects the image of the projection target object such that the size of the image of the projection target object on the projection surface coincides with the actual size of the projection target object. Thus, the display region calculation unit 23 substitutes the coordinate value Z_{W} in the Z_{W} axis direction in the coordinates (X_{W}, Y_{W}, Z_{W}) in the world coordinate system, which represents the position of each point of the projection target object corresponding to the object region in the rea space, with Z_{W}′ (=0). In doing so, the projection target object is virtually shifted to the projection surface.

Then, the display region calculation unit 23 calculates coordinates of each point of the projection target object after the shifting on the display surface of the projector 12 corresponding to the coordinates (X_{W}, Y_{W}, Z_{W}′) of the point in the world coordinate system. Here, a positional relationship between the projector 12 and the projection surface is also known. Therefore, coordinates of an arbitrary point on the world coordinate system can be converted into coordinates on a projector coordinate system with reference to the projector 12. The projector coordinate systems may be a coordinate system in which the center of the display surface of the projector 12 is set to an origin and an optical axis direction of the projector 12 and two directions that orthogonally intersect each other on a plane that orthogonally intersects the optical axis direction are set as axes in the same manner as in the depth sensor coordinate system, for example.

The display region calculation unit 23 converts the coordinates (X_{W}, Y_{W}, Z_{W}′) of each point of the projection target object into coordinates (X_{P}, Y_{P}, Z_{P}) on the projector coordinate system in accordance with the following equation.

$$( \begin{matrix}{X}_{p} \\ {Y}_{p} \\ {Z}_{p}\end{matrix} ) = {R}_{WP} ( \begin{matrix}{X}_{W} \\ {Y}_{W} \\ {Z}_{W}^{′}\end{matrix} ) + {t}_{WP} \\ {R}_{PW} = ( \begin{matrix}1 & 0 & 0 \\ 0 & cos PRotX & - sin PRotX \\ 0 & sin PRotX & cos PRotX\end{matrix} ) ( \begin{matrix}cos PRotY & 0 & sin PRotY \\ 0 & 1 & 0 \\ - sin PRotY & 0 & cos PRotY\end{matrix} ) ( \begin{matrix}cos PRotZ & - sin PRotZ & 0 \\ sin PRotZ & cos PRotZ & 0 \\ 0 & 0 & 1\end{matrix} ) , \\ {R}_{WP} = {R}_{PW}^{- 1} \\ {t}_{PW} = ( \begin{matrix}PLocX \\ PLocY \\ PLocZ\end{matrix} ) {t}_{WP} = {R}_{PW}^{- 1} {t}_{PW} \qquad ( 3 )$$

Here, R_{WP} is a rotation matrix representing the amount of rotation included in the affine transformation from the world coordinate system to the projector coordinate system, and t_{WP} is a parallel movement vector representing the amount of parallel movement included in the affine transformation. PLocX, PLocY, and PLocZ are coordinates of the center of the display surface of the projector 12 in the X_{W} axis direction, the Y_{W} axis direction, and the Z_{W} axis direction in the world coordinate system, namely the coordinates of the origin of the projector coordinate system, respectively. PRotX, ProtY, and ProtZ represent rotation angles of the optical axis of the projector 12 with respect to the X_{W} axis, the Y_{W} axis, and the Z_{W} axis, respectively. Since the projector 12 is attached so as to be directed downward in the vertical direction in the embodiment, the rotation matrix R_{WP} is a matrix in which only diagonal components have a value of ‘1’ and other components have a value of ‘0’.

Furthermore, the display region calculation unit 23 calculates coordinates (x_{P}, y_{P}) of each point of the projection target object on the display surface of the projector 12 corresponding to the coordinates (X_{P}, Y_{P}, Z_{P}) of the point in the projector coordinate system based on the pinhole model in accordance with the following equations.

$${x}_{p} = \frac{{f}_{p} \times {X}_{p}}{{Z}_{p}} + \frac{PW}{2} \\ {y}_{p} = \frac{{f}_{p} \times {Y}_{p}}{{Z}_{p}} + \frac{PH}{2} \\ {f}_{p} = \frac{\sqrt{{PW}^{2} + {PH}^{2}}}{2 tan \frac{PFovD}{2}} \qquad ( 4 )$$

Here, fp represents the focal length of the projector 12, and PW and PH represent the number of pixels in the horizontal direction and the number of pixels in the vertical direction of the display surface, respectively. PFovD represents a diagonal view angle of the projector 12.

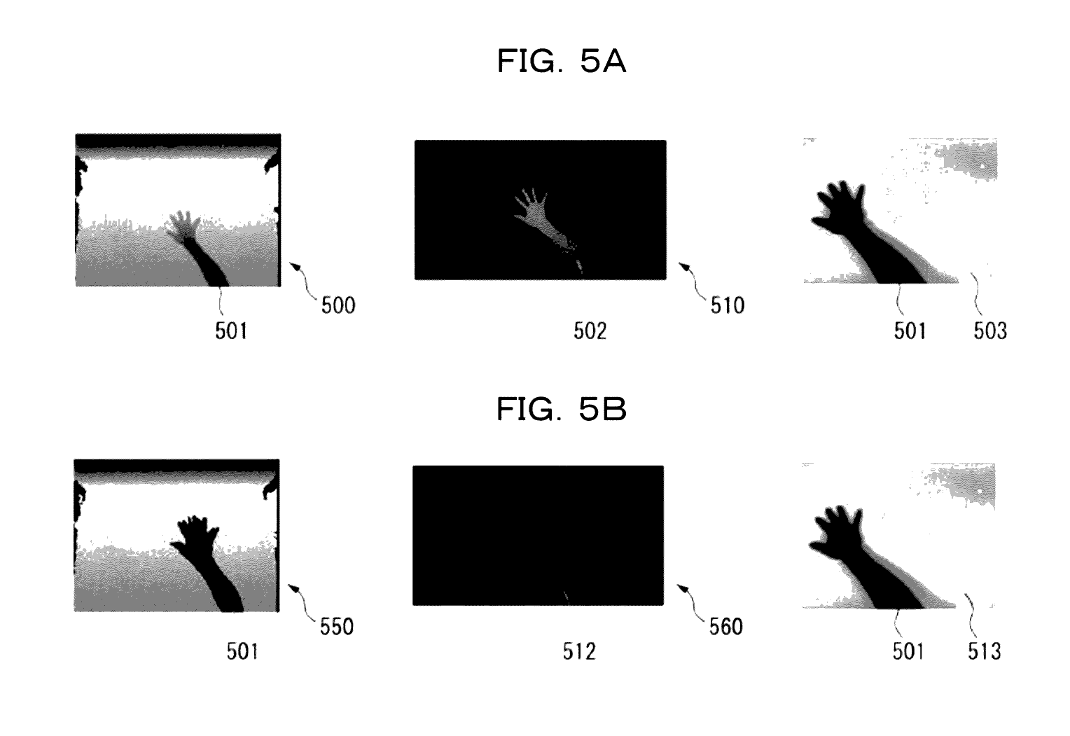

FIG. 5A illustrates an example of a depth image and a displayed image and a projected image of the projector 12 in a case where a projection target object is located at a position relatively far from the depth sensor 11, namely at a position close to the projection surface. In contrast, FIG. 5B illustrates an example of a depth image and a displayed image and a projected image of the projector 12 in a case where a projection target object is located at a position relatively close to the depth sensor 11, namely at a position far from the projection surface.

A projection target object 501 on a depth image 550 illustrated in FIG. 5B is larger than the projection target object 501 on a depth image 500 illustrated in FIG. 5A. This is because the projection target object 501 is located at a closer position to the depth sensor 11 in the case illustrated in FIG. 5B than in the case illustrated in FIG. 5A.

However, a size of an image 502 of the projection target object on a displayed image 510 illustrated in FIG. 5A substantially coincides with a size of an image 512 of the projection target object on a displayed image 560 illustrated in FIG. 5B. Therefore, a size of an image 503 of the projection target object on the projection surface illustrated in FIG. 5A substantially coincides with a size of an image 513 of the projection target object on the projection surface illustrated in FIG. 5B. Furthermore, both the size of the image 503 of the projection target object and the size of the image 513 of the projection target object substantially coincide with the actual size of the projection target object 501. As described above, it is possible to recognize that the projection apparatus 1 can project the image of the projection target object to the projection surface such that the size of the image of the projection target object coincides with the actual size of the projection target object regardless of the height of the projection target object from the projection surface at the time of capturing the image.

The projection control unit 24 projects the image of the projection target object to the projection surface by displaying the image of the projection target object in the display region on the display surface of the projector 12. At this time, the projection control unit 24 sets each pixel value in the display region to a predetermined value set in advance, for example.

However, since the projected image of the projector 12 is projected as a semi-transparent two-dimensional image on the projection surface, it is difficult for the user to recognize a difference between a height of the actual object on the projection surface and a height of the projection target object. Therefore, it may be difficult for the user to identify whether or not the projection target object is in contact with the object on the projection surface or is present in the air.

Thus, according to a modification example, the projection control unit 24 may adjust the pixel value in the display region of the projector 12 in accordance with a distance from the depth sensor 11 to the projection target object or a height from the projection surface 100 to the projection target object at the time of capturing the image. For example, the projection control unit 24 may determine a luminance value of each pixel in the display region in accordance with the following equation in a case where the projector 12 displays the projection target object with a grayscale.

$$Lv = \{ \begin{matrix}255 - {Z}_{w} & ( {Z}_{w} < 255 ) \\ 0 & ( {Z}_{w} \geq 255 )\end{matrix} \qquad ( 5 )$$

Here, Z_{W} represents a height (a value in units of mm, for example) of a point of the projection target object from the projection surface corresponding to a pixel to which attention is paid in the display region, and L_{V} represents a luminance value of the pixel to which attention is paid. Alternatively, the projection control unit 24 may determine the luminance value of each pixel in the display region in accordance with the following equation instead of Equation (5).

$$Lv = 255 - \frac{{Z}_{w}}{{Z}_{max}} \times 255 \qquad ( 6 )$$

Here, Zₘₐₓ represents an assumed maximum value of the height of the projection target object with respect to the projection surface 100.

The projection control unit 24 may project the image of the projection target object with colors by the projector 12. In such a case, the projection control unit 24 may set a value calculated by Equation (5) or (6) for any one or two colors among red (R), green (G), and blue (B) and set a fixed value for the other color for each pixel in the display region, for example.

It becomes easier for the user to recognize the actual height of the projection target object at the time of capturing the image by changing the color or the luminance of the image of the projection target object projected by the projector 12 at the time of projecting the image in accordance with the actual height of the projection target object from the projection surface at the time of capturing the image. Therefore, the user can easily identify whether or not the projection target object is in contact with the object on the projection surface or is present in the air, based on the image of the projection target object.

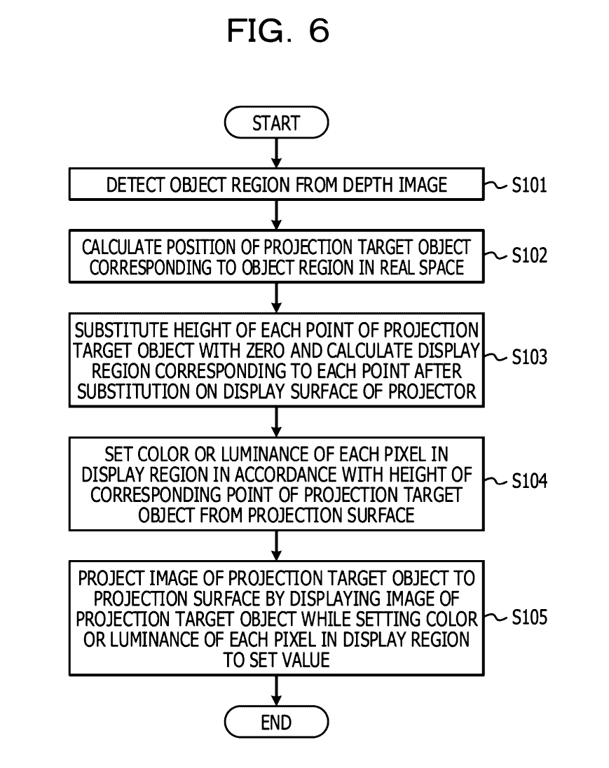

FIG. 6 is an operation flowchart of the projection processing executed by the control unit 14. The control unit 14 executes the projection processing on each of the plurality of depth images captured while the instructor executes a series of operations in accordance with the operation flowchart described below.

The object region detection unit 21 detects an object region in which the projection target object is captured in a depth image obtained by the depth sensor 11 (Step S101). Then, the object region detection unit 21 provides information about the object region to the real space position calculation unit 22.

The real space position calculation unit 22 calculates a position of the projection target object in the real space by calculating coordinates of a point of the projection target object, which is captured at each pixel in the object region, in the world coordinate system (Step S102). Then, the real space position calculation unit 22 provides information about the coordinates of each point of the projection target object corresponding to the object region in the world coordinate system to the display region calculation unit 23.

The display region calculation unit 23 calculates a display region on the display surface by substituting a height of each point of the projection target object from the projection surface in the world coordinate system with zero and calculating coordinates of the corresponding pixel on the display surface of the projector 12 (Step S103).

The projection control unit 24 sets a color or luminance of each pixel in the display region on the display surface of the projector 12 to a value in accordance with the height of the point of the projection target object corresponding to the pixel from the projection surface (Step S104). Then, the projection control unit 24 projects the image of the projection target object to the projection surface by displaying the image of the projection target object on the display surface of the projector 12 such that the color or the luminance of each pixel in the display region is the set value (Step S105). Then, the control unit 14 completes the projection processing.

The control unit 14 may execute the processing in Steps S101 and S102 on each depth image every time the depth image is obtained at the time of capturing the image and save, in the storage unit 13, the coordinates of each point of the projection target object corresponding to the object region in the world coordinate system. In doing so, the control unit 14 can save the amount of operation at the time of projecting the image.

As described above, the projection apparatus obtains the position of the projection target object in the real space at the time of capturing the image, based on the depth images obtained by imaging the projection target object with the depth sensor. Then, the projection apparatus obtains a corresponding display region on the display surface of the projector when the position of the projection target object in the real space is virtually shifted to the projection surface, and displays the image of the projection target object in the display region. Therefore, the projection apparatus projects the image of the projection target object such that the size of the image of the projection target object on the projection surface coincides with the actual size of the projection target object even if the projection target object is located at a higher position than the projection surface at the time of capturing the image. Furthermore, the projection apparatus sets the color or the luminance of each point at the time of projecting the image in accordance with the height from the projection surface to each point of the projection target object at the time of capturing the image. Therefore, the user can easily recognize the height from the projection surface to each point of the projection target object at the time of capturing the image based on the projected image of the projection target object.

There is a case where the location of the object as a target of operation by the projection target object differs at the time of capturing the image and at the time of projecting the image. In such a case, it is preferable that the location of the image of the projection target object is positioned relative to the location of the object as the target of the operation at the time of projecting the image.

Thus, according to a second embodiment, the projection apparatus positions the location where the projection target object is to be projected relative to the position of the operation target object. In the embodiment, the surface of the operation target object or the surface of the work platform on which the operation target object is mounted is the surface to which the image of the projection target object is projected. In addition, it is assumed that the world coordinate system is set with reference to the surface of the work platform.

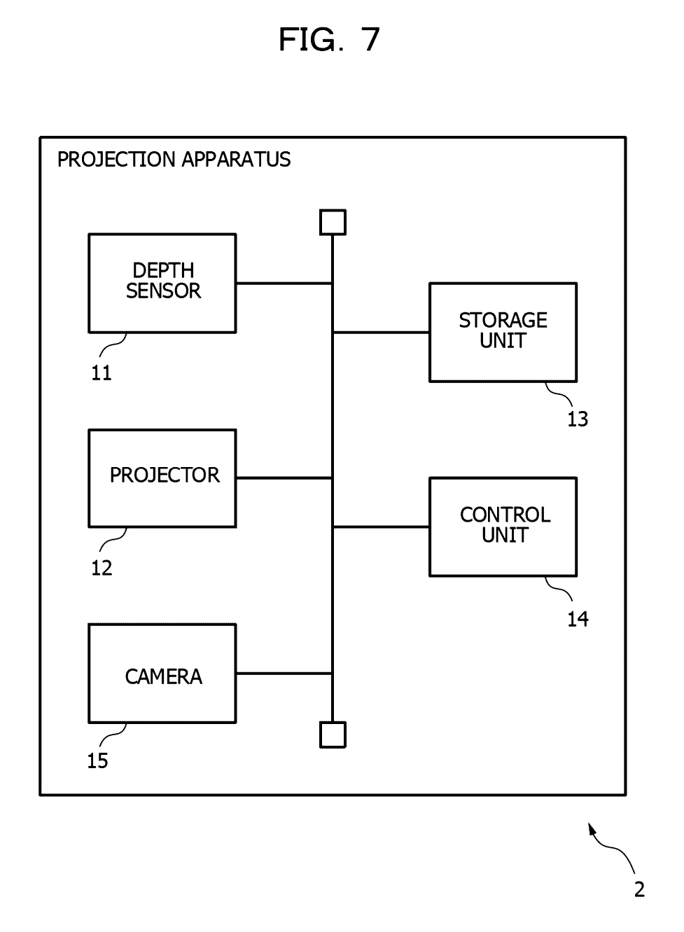

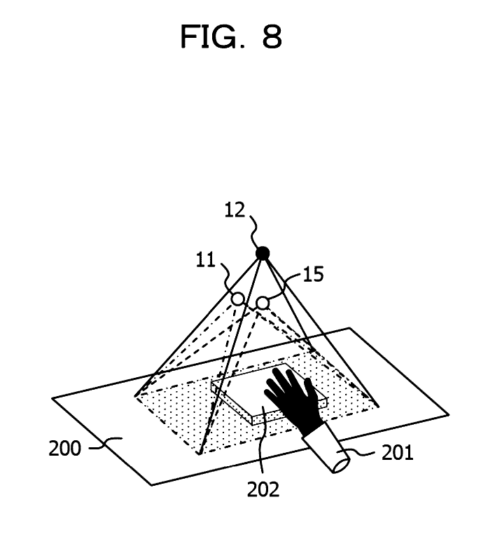

FIG. 7 is a hardware configuration diagram of a projection apparatus according to the second embodiment. FIG. 8 is a diagram illustrating an example of a relationship between the respective components of the projection apparatus according to the second embodiment and a projection surface. A projection apparatus 2 includes a depth sensor 11, a projector 12, a storage unit 13, a control unit 14, and a camera 15. The depth sensor 11, the projector 12, the storage unit 13, and the camera 15 are respectively coupled to the control unit 14 via signal lines. The projection apparatus 2 may further include a communication interface (not illustrated) for coupling the projection apparatus 2 to other devices.

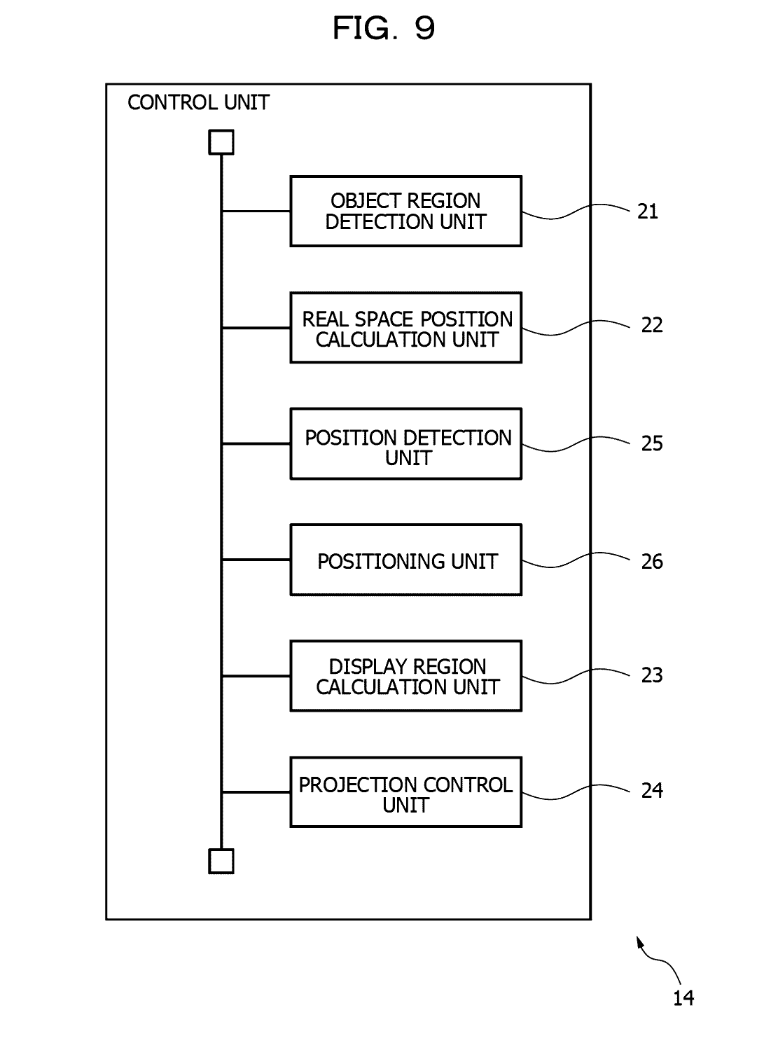

FIG. 9 is a functional block diagram of the control unit according to the second embodiment. The control unit 14 according to the second embodiment includes an object region detection unit 21, a real space position calculation unit 22, a display region calculation unit 23, a projection control unit 24, a position detection unit 25, and a positioning unit 26. The projection apparatus 2 according to the second embodiment is different from the projection apparatus 1 according to the first embodiment in that the projection apparatus 2 includes the camera 15 and the control unit 14 includes the position detection unit 25 and the positioning unit 26. Hereinafter, description will be given of the camera 15, the position detection unit 25, the positioning unit 26, and related parts thereof. See the description of corresponding components in the projection apparatus 1 according to the first embodiment for other components of the projection apparatus 2.

The camera 15 is an example of an imaging unit. As illustrated in FIG. 8, The camera 15 is attached so as to be directed toward a projection direction of the projector 12 such that a surface 200 of a work platform, a projection target object 201 and an operation target object 202 mounted on the surface 200 of the work platform are included in an imaging range of the camera 15. The camera 15 generates an image at a specific cycle (30 frames/second to 60 frames/second, for example) at the time of imaging the projection target object (during a series of operations by an instructor, for example). Then, the camera 15 outputs the generated image to the control unit 14 every times the camera 15 generates the image. The image generated by the camera 15 may be a gray image or a color image. In the embodiment, it is assumed that the camera 15 generates a color image. The depth sensor 11 and the projector 12 are attached so as to be directed toward the surface 200 of the work platform from an upper side in the same manner as in the first embodiment.

Hereinafter, description will be given of processing performed by the respective components of the control unit 14 at the time of capturing the image and at the time of projecting the image.

(At the Time of Capturing an Image)

The object region detection unit 21 detects an object region where the projection target object is captured from each depth images obtained at the time of capturing the image in the same manner as in the first embodiment. Then, the object region detection unit 21 provides information about the object region in each depth image to the real space position calculation unit 22.

The real space position calculation unit 22 calculates a position of a point of the projection target object, which is captured at each pixel in the object region, in the real space for each depth image obtained at the time of capturing the image in the same manner as in the first embodiment. At this time, the real space position calculation unit 22 also obtains a height Z_{wmin} of a point closest to the surface of the work platform from the surface thereof from among the respective points of the projection target object corresponding to the respective pixels in the object region for each depth image.

Furthermore, the real space position calculation unit 22 calculates the positions of the surface of the work platform and each point of the operation target object in the real space from the depth image in a case where no projection target object is present in the detection range of the depth sensor 11, that is, the depth image in which the surface of the work platform and the operation target object are captured. In such a case, the real space position calculation unit 22 may execute, on each pixel included in the depth image, the same processing as the processing on each pixel in the object region and calculate coordinates of each point in the world coordinate system. In a case where a projection available range of the projector 12 on the surface of the work platform is narrower than the detection range of the depth sensor 11 on the surface of the work platform, the real space position calculation unit 22 may calculate the positions of the surface of the work platform and each point of the operation target object in the real space within the projection available range.

The real space position calculation unit 22 saves the minimum distance Z_{wmin} from the position of each point of the projection target object in the real space corresponding to each depth image and the surface of the work platform to the projection target object in the storage unit 13. In addition, the real space position calculation unit 22 saves, in the storage unit 13, the positions of the surface of the work platform and each point of the operation target object in the real space.

The position detection unit 25 detects the position of the operation target object from an image in a case where the projection target object is not present in an imaging range of the camera 15. Therefore, the position detection unit 25 detects a plurality of feature points of a marker, for example, four corner points of the marker provided at the operation target object. For example, the position detection unit 25 detects the positions of the respective feature points of the marker on the image by template matching between a template representing the marker and the image. The position detection unit 25 uses a gravity center position of the marker or some feature point, for example as a reference point. Then, the position detection unit 25 calculates an affine transformation parameter that represents conversion between a camera coordinate system and a target object coordinate system with reference to the operation target object based on the plurality of detected feature points of the marker. At this time, the position detection unit 25 may calculate the affine transformation parameter based on the method described in Kato et. al., “An Augmented Reality System and its Calibration based on Marker Tracking”, Transaction of the Virtual Reality Society of Japan, 4(4), pp. 607 to 616, December 1999, for example. The position detection unit 25 may calculate the affine transformation parameter that represents the conversion between the camera coordinate system and the target object coordinate system based on a plurality of corners of the operation target object detected by applying a corner detection filter such as a Harris filter to the image. In such a case, the position detection unit 25 may use some detected corner as a reference point.

According to a modification example, the position detection unit 25 may detect a plurality of feature points and a reference point of the operation target object based on a depth image. In such a case, the position detection unit 25 may detect, as the reference point, the highest point with respect to the work platform in the depth image in which the surface of the work platform and the operation target object are captured, for example. Alternatively, the position detection unit 25 may set, as the reference point of the operation target object, a gravity center of a group of pixels with values representing that the pixels are closer to the depth sensor 11 than to the surface of the work platform in the depth image in which the surface of the work platform and the operation target object are captured. Furthermore, the position detection unit 25 may detect a plurality of feature points of the operation target object, for example, the respective end points of the group on upper, lower, left, and right sides, from the depth image and calculate the affine transformation parameter representing the conversion between the depth sensor coordinate system and the target object coordinate system based on the plurality of feature points. The position detection unit 25 saves coordinate values of the reference point of the operation target object on the depth image or the image and the affine transformation parameter representing the conversion between the camera coordinate system or the depth sensor coordinate system and the target object coordinate system in the storage unit 13.

(At the Time of Projecting an Image)

Next, description will be given of processing at the time of projecting an image. At the time of projecting an image, the control unit 14 causes the camera 15 to generate an image in which the surface of the work platform and the operation target object are captured before starting the projection in order to specify the position of the operation target object. Alternatively, the control unit 14 may cause the depth sensor 11 to generate a depth image in which the surface of the work platform and the operation target object are captured. Then, the position detection unit 25 detects a reference point of the operation target object from the image or the depth image, in which the surface of the work platform and the operation target object are captured, which is obtained before starting the projection, in the same manner as in the case of capturing the image. In addition, the position detection unit 25 calculates an affine transformation parameter between the target object coordinate system and the camera coordinate system with reference to the operation target object. Then, the position detection unit 25 provides information about the coordinates of the reference point on the image or the depth image and the affine transformation parameter between the target object coordinate system and the camera coordinate system to the positioning unit 26.

The positioning unit 26 determines the position of the image of the projection target object on the projection surface based on a positional relationship between the position of the operation target object and the projection target object at the time of capturing the image and the position of the operation target object at the time of projecting the image.

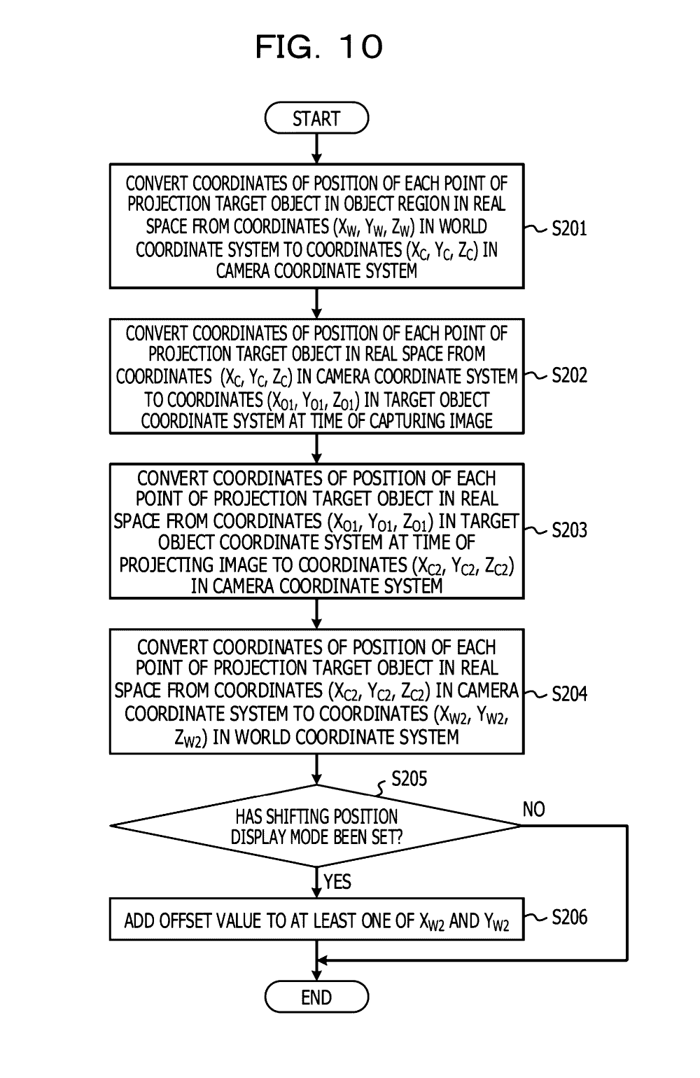

FIG. 10 is an operation flowchart of positioning processing. Since the positioning unit 26 executes the same processing on the respective depth images obtained at the time of capturing the images, processing performed on a single depth image will be described below.

The positioning unit 26 converts the coordinates of the position of each point of the projection target object in the objected region detected in the depth image in the real space from the coordinates in the world coordinate system to the coordinates in the camera coordinate system (Step S201). At this time, the positioning unit 26 converts coordinates (X_{W}, Y_{W}, Z_{W}) of each point of the projection target object in the world coordinate system into coordinates (X_{C}, Y_{C}, Z_{C}) in the camera coordinate system in accordance with the following equation.

$$( \begin{matrix}{X}_{C} \\ {Y}_{C} \\ {Z}_{C}\end{matrix} ) = {R}_{WC} ( \begin{matrix}{X}_{W} \\ {Y}_{W} \\ {Z}_{W}\end{matrix} ) + {t}_{WC} \\ {R}_{CW} = ( \begin{matrix}1 & 0 & 0 \\ 0 & cos CRotX & - sin CRotX \\ 0 & sin CRotX & cos PRotX\end{matrix} ) ( \begin{matrix}cos CRotY & 0 & sin CRotY \\ 0 & 1 & 0 \\ - sin CRotY & 0 & cos CRotY\end{matrix} ) ( \begin{matrix}cos CRotZ & - sin CRotZ & 0 \\ sin CRotZ & cos CRotZ & 0 \\ 0 & 0 & 1\end{matrix} ) \\ {R}_{WC} = {R}_{CW}^{- 1} \\ {t}_{CW} = ( \begin{matrix}CLocX \\ CLocY \\ CLocZ\end{matrix} ) , \\ {t}_{WC} = {R}_{CW}^{- 1} {t}_{CW} \qquad ( 7 )$$

Here, R_{WC} is a rotation matrix representing the amount of rotation included in the affine transformation from the world coordinate system to the camera coordinate system, and t_{WC} is a parallel movement vector representing the amount of parallel movement included in the affine transformation. R_{CW} is a rotation matrix included in the affine transformation from the camera coordinate system to the world coordinate system, and t_{CW} is a parallel movement vector representing the amount of parallel movement included in the affine transformation. CLocX, CLocY, and CLocZ are coordinates of the center of an image sensor of the camera 15 in the X_{W} axis direction, the Y_{W} axis direction, and the Z_{W} axis direction in the world coordinate system, respectively, that is, coordinates of the origin of the camera coordinate system. CRotX, CRotY, and CRotZ represent rotation angles of the optical axis direction of the camera 15 with respect to the X_{W} axis, the Y_{W} axis, and the Z_{W} axis, respectively. In this example, the rotation angles of the optical axis direction of the camera 15 with respect to the Y_{W} axis and the Z_{W} axis are zero.

Next, the positioning unit 26 converts coordinates of each point of the projection target object in the object region detected in the depth image in the real space from coordinates (X_{C}, Y_{C}, Z_{C}) in the camera coordinate system to coordinates (X_{O1}, Y_{O1}, Z_{O1}) in a coordinate system with reference to the operation target object at the time of capturing the image (Step S202). Hereinafter, the coordinate system with reference to the operation target object at the time of capturing the image will be referred to as a first target object coordinate system. The positioning unit 26 converts the coordinates (X_{C}, Y_{C}, Z_{C}) of each point of the projection target object in the camera coordinate system into the coordinates (X_{O1}, Y_{O1}, Z_{O1}) in the first target object coordinate system in accordance with the following equation.

$$( \begin{matrix}{X}_{O 1} \\ {Y}_{O 1} \\ {Z}_{O 1}\end{matrix} ) = {R}_{CO 1} ( \begin{matrix}{X}_{C} \\ {Y}_{C} \\ {Z}_{C}\end{matrix} ) + {t}_{CO 1} \\ {R}_{CO 1} = ( \begin{matrix}1 & 0 & 0 \\ 0 & cos CO 1 RotX & - sin CO 1 RotX \\ 0 & sin CO 1 RotX & cos CO 1 RotX\end{matrix} ) ( \begin{matrix}cos CO 1 RotY & 0 & sin CO 1 RotY \\ 0 & 1 & 0 \\ - sin CO 1 RotY & 0 & cos CO 1 RotY\end{matrix} ) ( \begin{matrix}cos CO 1 RotZ & - sin CO 1 RotZ & 0 \\ sin CO 1 RotZ & cos CO 1 RotZ & 0 \\ 0 & 0 & 1\end{matrix} ) \\ {t}_{CO 1} = ( \begin{matrix}CLocX 1 \\ CLocY 1 \\ CLocZ 1\end{matrix} ) \qquad ( 8 )$$

Here, R_{CO1} is a rotation matrix representing the amount of rotation included in the affine transformation from the camera coordinate system into the first target object coordinate system, and t_{CO1} is a parallel movement vector representing the amount of parallel movement included in the affine transformation. CLocX1, CLocY1, and CLocZ1 are coordinates of the origin of the camera coordinate system in an Xo1 axis direction, a Yo1 axis direction, and a Zo1 axis direction of the first target object coordinate system, respectively. CO1RotX, CO1RotY, and CO1RotZ represent rotation angles of the optical axis direction of the camera 15 with respect to the Xo1 axis, the Yo1 axis, and the Zo1 axis, respectively.

Next, the positioning unit 26 converts the coordinates of each point of the projection target object in the object region detected in the depth image in the real space from the coordinates (X_{O1}, Y_{O1}, Z_{O1}) in the coordinate system with reference to the operation target object at the time of projecting the image to coordinates (X_{C2}, Y_{C2}, Z_{C2}) in the camera coordinate system (Step S203). Hereinafter, the coordinate system with reference to the operation target object at the time of projecting the image will be referred to as a second target object coordinate system. In a case where a relative positional relationship of the projection target object with respect to the operation target object at the time of capturing the image is the same as a relative positional relationship of the image of the projection target object with respect to the operation target object at the time of projecting the image, the position of the projection target object is the same in both the first and second target object coordinate systems. However, a positional relationship between the first target object coordinate system and the camera coordinate system may differ from a positional relationship between the second target object coordinate system and the camera coordinate system depending on a difference between the position of the operation target object at the time of capturing the image and the position of the operation target object at the time of projecting the image. Thus, the positioning unit 26 converts the coordinates (X_{O1}, Y_{O1}, Z_{O1}) of each point of the projection target object in the second (first) target object coordinate system into coordinates (X_{C21} Y_{C2}, Z_{C2}) in the camera coordinate system in accordance with the following equation.

$$( \begin{matrix}{X}_{C 2} \\ {Y}_{C 2} \\ {Z}_{C 2}\end{matrix} ) = {R}_{OC 2} ( \begin{matrix}{X}_{O 1} \\ {Y}_{O 1} \\ {Z}_{O 1}\end{matrix} ) + {t}_{OC 2} \\ {R}_{CO 2} = ( \begin{matrix}1 & 0 & 0 \\ 0 & cos CO 2 RotX & - sin CO 2 RotX \\ 0 & sin C O 2 RotX & cos CO 2 RotX\end{matrix} ) ( \begin{matrix}cos CO 2 RotY & 0 & sin CO 2 RotY \\ 0 & 1 & 0 \\ - sin CO 2 RotY & 0 & cos CO 2 RotY\end{matrix} ) ( \begin{matrix}cos CO 2 RotZ & - sin CO 2 RotZ & 0 \\ sin CO 2 RotZ & cos CO 2 RotZ & 0 \\ 0 & 0 & 1\end{matrix} ) . \\ {R}_{OC 2} = {R}_{CO 2}^{- 1} \\ {t}_{CO 2} = ( \begin{matrix}CLocX 2 \\ CLocY 2 \\ CLocZ 2\end{matrix} ) , \\ {t}_{OC 2} = {R}_{OC 2} {t}_{CO 2} \qquad ( 9 )$$

Here, R_{OC2} is a rotation matrix representing the amount of rotation included in the affine transformation from the second target object coordinate system to the camera coordinate system, and t_{OC2} is a parallel movement vector representing the amount of parallel movement included in the affine transformation. CLocX2, CLocY2, and CLocZ2 are coordinates of the origin of the camera coordinate system in an Xo2 axis direction, a Yo2 axis direction, and a Zo2 axis direction of the second target object coordinate system, respectively. CO2RotX, CO2RotY, and CO2RotZ represent rotation angles of the optical axis of the camera 15 with respect to the Xo2 axis, the Yo2 axis, and the Zo2 axis, respectively.

In doing so, the position of the projection target object at the time of projecting the image viewed from the camera 15 is obtained.

Next, the positioning unit 26 converts the coordinates of each point of the projection target object in the object region detected in the depth image in the real space from the coordinates (X_{C2}, Y_{C2}, Z_{C2}) in the camera coordinate system to coordinates (X_{W2}, Y_{W2}, Z_{W2}) in the world coordinate system (Step S204). At this time, the positioning unit 26 converts the coordinates (X_{C2}, Y_{C2}, Z_{C2}) of each point of the projection target object in the camera coordinate system into the coordinates (X_{W2}, Y_{W2}, Z_{W2}) in the world coordinate system in accordance with the following equation.

$$( \begin{matrix}{X}_{W 2} \\ {Y}_{W 2} \\ {Z}_{W 2}\end{matrix} ) = {R}_{CW} ( \begin{matrix}{X}_{C 2} \\ {Y}_{C 2} \\ {Z}_{C 2}\end{matrix} ) + {t}_{CW} \qquad ( 10 )$$

In doing so, the position of the projection target object at the time of projecting the image in the world coordinate system, which has been positioned with respect to the operation target object, is obtained.

The positioning unit 26 determines whether or not a shifting position display mode has been set (Step S205). The shifting position display mode is a mode in which a projection position of the image of the projection target object is made to shift from the location positioned with respect to the operation target object by a predetermined distance. The shifting position display mode is set in advance via a user interface (not illustrated) of the projection apparatus 2, for example. If the image of the projection target object is projected on the operation target object, it becomes difficult to view any of the operation target object and the image of the projection target object in some cases. Thus, the projection apparatus 2 can provide easy viewing of both the operation target object and the image of the projection target object by setting the shifting position display mode and projecting the image of the projection target object at a location shifted from the operation target object by a predetermined positional relationship. Whether or not the shifting position display mode has been set is displayed by using a flag which is saved in the storage unit 13 and represents whether or not the shifting position display mode has been set, for example.

In a case where the shifting position display mode has been set (Yes in Step S205), the positioning unit 26 add a predetermined offset value to at least one of a coordinate value X_{W2} of the Xw axis and a coordinate value Y_{W2} of the Yw axis of each point of the projection target object in the world coordinate system (Step S206). The predetermined offset value may be a value from 1 cm to 5 cm, for example.

After Step S206 or in a case where the shifting position display mode has not been set in Step S205 (No in Step S205), the positioning unit 26 completes the positioning processing. Then, the positioning unit 26 saves the coordinate values of each point of the projection target object after the positioning in the storage unit 13.

According to a modification example, the positioning unit 26 may move the coordinates (X_{O1}, Y_{O1}, Z_{O1}) of each point of the projection target object in the first target object coordinate system obtained in Step S202 in accordance with the equation of affine transformation for conversion from the second target object coordinate system to the world coordinate system. In doing so, the positioning unit 26 converts the coordinates (X_{O1}, Y_{O1}, Z_{O1}) of each point of the projection target object into the coordinates (X_{W2}, Y_{W2}, Z_{W2}) in the world coordinate system.

The display region calculation unit 23 calculates the display region by calculating the coordinates of each point of the projection target object, which is detected in each depth image obtained at the time of capturing the image and is positioned with respect to the operation target object, on the display surface of the projector 12.

Since the image of the projection target object is positioned with respect to the operation target object in the embodiment, the image of the projection target object is projected on the operation target object. Thus, the display region calculation unit 23 sets a value Z_{W2} of each point of the projection target object in a height direction to a height Z_{W2}′ of the operation target object at the time of projecting the image. For example, the display region calculation unit 23 substitutes the value Z_{W2} of each point of the projection target object in the height direction with the height value Z_{W2}′ of the reference point at the time of projecting the image in the real space. Alternatively, the display region calculation unit 23 may set the value Z_{W2} of each point of the projection target object in the height direction to the height Z_{W2}′ of the operation target object at a position (X_{W2}, Y_{W2}) in an XwYw plane of the point. In doing so, the position of the projection target object is virtually shifted to the surface of the operation target object. In the case where the shifting position mode has been set, the display region calculation unit 23 may set Z_{W2}′ to the height of the surface of the work platform, that is, zero.

Then, the display region calculation unit 23 converts the coordinates (X_{W2}, Y_{W2}, Z_{W2}′) of each point of the projection target object in the world coordinate system to the coordinate values in the projector coordinate system in accordance with Equation (3) in the same manner as in the first embodiment.

Furthermore, the display region calculation unit 23 may calculate the coordinates of each point of the projection target object on the display surface of the projector 12 corresponding to the coordinates in the projector coordinate system in accordance with Equation (4) in the same manner as in the first embodiment.

The projection control unit 24 displays the image of the projection target object in the display region on the display surface of the projector 12 corresponding to the object region detected from each depth image based on the depth image obtained at the time of capturing the image in the same manner as in the first embodiment. In doing so, the projection control unit 24 projects the image of the projection target object to the projection surface (the surface of the operation target object or the work platform). In the embodiment, the projection control unit 24 sets each pixel value in the display region to a pixel value of the image, in which the point of the projection target object corresponding to the pixel is captured, which is obtained by the camera 15.

Thus, the projection control unit 24 specify the coordinates (x_{C}, y_{C}) of the pixel, which corresponds to each point of the projection target object detected from each depth image and corresponds to the coordinates (X_{C}, Y_{C}, Z_{C}) in the camera coordinate system, in the image obtained by the camera 15 in accordance with the following equation.

$${x}_{c} = \frac{{f}_{c} \times {X}_{C}}{{Z}_{C}} + \frac{CW}{2} \\ {y}_{c} = \frac{{f}_{c} \times {Y}_{C}}{{Z}_{C}} + \frac{CH}{2} \\ {f}_{c} = \frac{\sqrt{{CW}^{2} + {CH}^{2}}}{2 tan \frac{CFovD}{2}} \qquad ( 11 )$$

Here, fc represents a focal length of the camera 15, and CW and CH represents the number of pixels in the horizontal direction and the number of pixels in the vertical direction of the image obtained by the camera 15, respectively. CFovD represents a diagonal view angle of the camera 15.

The projection control unit 24 obtains, in an image obtained at clock time closest to the time of acquiring a depth image, the pixel value at (x_{C}, y_{C}) corresponding to each point of the projection target object detected in the depth image. Then, the projection control unit 24 sets the pixel value as the pixel value corresponding to the point of the projection target object on the display surface of the projector 12. In doing so, the projection control unit 24 projects the image of the projection target object obtained by the camera 15.

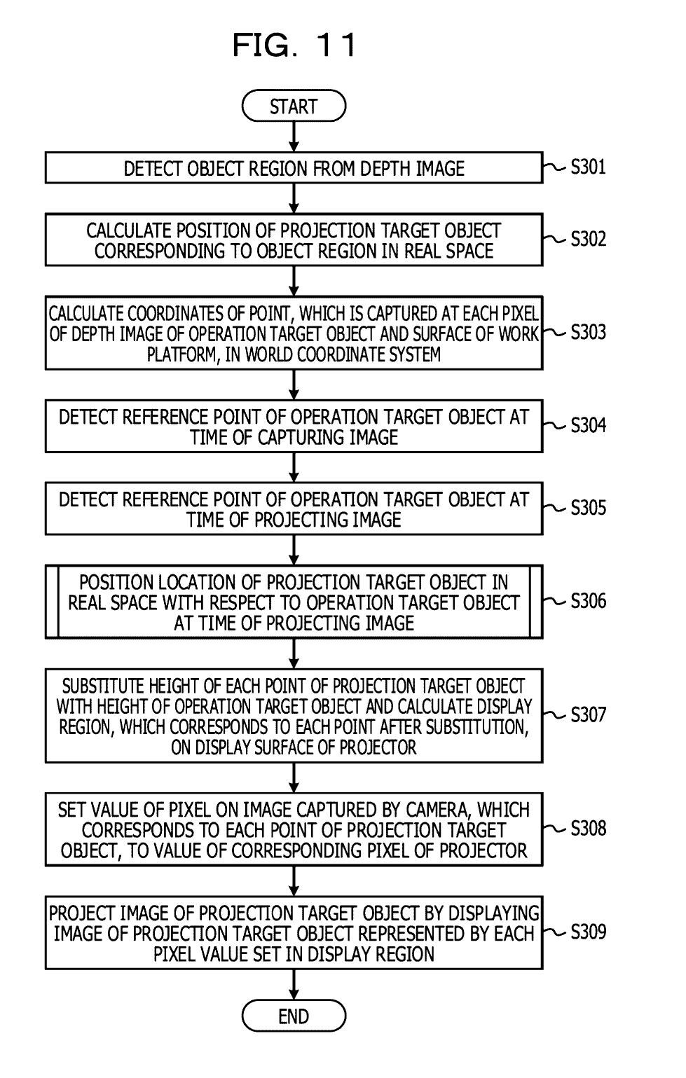

FIG. 11 is an operation flowchart of projection processing according to the second embodiment.

The object region detection unit 21 detects the object region where the projection target object is captured on each depth image obtained by the depth sensor 11 at the time of capturing the image (Step S301). Then, the object region detection unit 21 provides information about the object region to the real space position calculation unit 22.

The real space position calculation unit 22 calculates the position of the projection target object in the real space by calculating the coordinates of each point of the projection target object corresponding to the object region in each depth image in the world coordinate system (Step S302). Then, the real space position calculation unit 22 saves, in the storage unit 13, the coordinates of each point of the projection target object in each depth image in the world coordinate system. Furthermore, the real space position calculation unit 22 calculates the coordinates of a point, which is captured at each pixel of the depth image in which the operation target object and the surface of the work platform is captured, in the world coordinate system and saves the coordinates in the storage unit 13 (Step S303).

Furthermore, the position detection unit 25 detects a reference point of the operation target object from the depth image in which the operation target object and the surface of the work platform are captured or the image obtained by the camera 15 at the time of capturing the image and saves the reference point in the storage unit 13 (Step S304).

Similarly, the position detection unit 25 detects the reference point of the operation target object from the depth image in which the operation target object and the surface of the work platform are captured and the image obtained by the camera 15 at the time of projecting the image and saves the reference point in the storage unit 13 (Step S305).

The positioning unit 26 positions the location of the projection target object detected in each depth image, which is obtained at the time of capturing the image, in the real space with respect to the operation target object at the time of projecting the image (Step S306).

The display region calculation unit 23 substitutes the height of each point of the projection target object detected in each depth image obtained at the time of capturing the image from the surface of the work platform in the world coordinate system with the height of the operation target object. Then, the display region calculation unit 23 calculates the display region on the display surface by calculating the coordinates of the pixel, which corresponds to each point of the projection target object detected in each depth image obtained at the time of capturing the image, on the display surface of the projector 12 (Step S307).

The projection control unit 24 sets a value of a pixel, which corresponds to each point of the projection target object detected in each depth image obtained at the time of capturing the image, on the image obtained by the camera 15 to a value of the corresponding pixel of the projector 12 (Step S308). Then, the projection control unit 24 sequentially displays the image of the projection target object represented by the set value of each pixel corresponding to the depth image on the display region of the projector 12 in accordance with an order in which the depth image is captured. In doing so, the projection control unit 24 projects the image of the projection target object to the surface of the operation target object or the work platform (Step S309). Then, the control unit 14 completes the projection processing. The control unit 14 may perform only saving of each depth image in the storage unit 13 at the time of capturing the image in the same manner as in the first embodiment and execute the processing in Steps S301 to S304 together at the time of projecting the image.

According to the second embodiment, the projection apparatus positions the image of the projection target object with respect to the operation target object and projects the image even if the position of the operation target object differs at the time of capturing the image and at the time of projecting the image as described above. Since the projection apparatus adjusts the position of the projection target object in the real space with respect to the height of the operation target object and then calculates the display region, the projection apparatus projects the image of the projection target object such that the size of the image of the projection target object projected on the operation target object coincides with the actual size of the projection target object. Furthermore, since the projection apparatus projects the image of the projection target object captured by the camera on the operation target object, reality of the projected image of the projection target object is enhanced.

According to the modification examples of the aforementioned respective embodiments, the projection control unit 24 may change the color of the outline of the image of the projection target object at the time of projecting the image in accordance with the height from the surface of the work platform to the projection target object at the time of capturing the image.

In such a case, the projection control unit 24 detects the outline of the display region on the display surface of the projector 12, which corresponds to the projection target object detected in each depth image obtained at the time of capturing the image. The projection control unit 24 sets such pixels that any of adjacent pixels are not included in the display region from among the respective pixels included in the display region as pixels on the outline. Then, the projection control unit 24 sets a value of each pixel on the outline to (R, G, B)=(255−Zwmin, 0, Zmin). Zmin is the height o the projection target object from the surface of the work platform at the point closest to the surface of the work platform. By setting the value of each pixel on the outline as described above, the color of the outline of the image of the projection target object approaches red at the time of projecting the image as the projection target object is located at a position closer to the surface of the work platform at the time of capturing the image. In contrast, the color of the outline of the image of the projection target object approaches blue at the time of projecting the image as the projection target object is located at a position further from the surface of the work platform at the time of capturing the image.

The projection control unit 24 may thicken the outline of the display region. In such a case, the projection control unit 24 may repeat an expansion operation of the Morphological operation a predetermined number of times on a group of the pixels on the outline of the display region, for example.

According to another modification example, the projection control unit 24 may change the size of the outline of the image of the projection target object at the time of projecting the image in accordance with the height from the surface of the work platform to the projection target object at the time of capturing the image. For example, the projection control unit 24 may increase the size of the outline of the image of the projection target object as the height from the surface of the work platform to the projection target object increases.

In such a case, the projection control unit 24 obtains a pixel (hereinafter, referred to as a left pixel) on the outline, at which the coordinate in the horizontal direction reaches the minimum value, and a pixel (hereinafter, referred to as a right pixel) on the outline, at which the coordinate in the horizontal direction reaches the maximum value for each coordinate in the vertical direction on the display surface of the projector 12, for example. Then, the projection control unit 24 shifts the left pixel of the coordinate in the vertical direction by Zwmin/10 in the left direction along the horizontal direction and shifts the right pixel of the coordinate in the vertical direction by Zwmin/10 in the right direction along the horizontal direction for each coordinate in the vertical direction on the display surface of the projector 12.

Alternatively, the projection control unit 24 may convert the coordinates (X_{W2}, Y_{W2}, Z_{W2}) of each point of the projection target object in the world coordinate system into coordinates in the projector coordinate system in accordance with Equation (3) without any other operation and obtain the coordinates on the display surface of the projector 12 from the coordinates after the conversion in accordance with Equation (4). In doing so, a range of the projection target object on the display surface in accordance with the height of the projection target object from the surface of the work platform at the time of capturing the image is obtained. Then, the projection control unit 24 may display the value of each pixel on the outline within the range with a predetermined color along with the aforementioned display region. In such a case, the size of the projected outline is the size of the projection target object viewed from the depth sensor 11 at the time of capturing the image.

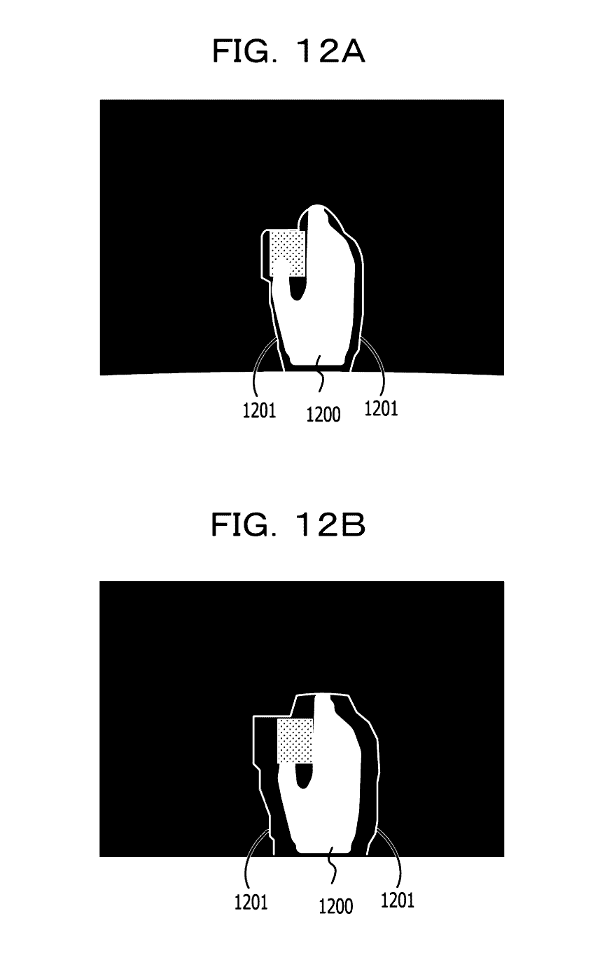

FIG. 12A illustrates an example of an image of a projection target object in a case where the height of the projection target object from the surface of the work platform at the time of capturing the image is relatively low in the modification example. FIG. 12B illustrates an example of an image of a projection target object in a case where the height of the projection target object from the surface of the work platform at the time of capturing the image is relatively high in the modification example.

FIG. 12A illustrates an outline 1201 along an image 1200 of the projection target object. In contrast, FIG. 12B illustrates the outline 1201 expanded in the horizontal direction as compared with the image 1200 of the projection target object. Therefore, the user can recognize the height of the projection target object at the time of capturing the image from the outline of the projection target object.

The projection control unit 24 may change the color of each pixel on the outline in accordance with the height from the surface of the work platform to the projection target object at the time of capturing the image even in the modification example.

There is a case where the number of pixels of the depth sensor is larger than the number of pixels of the display surface of the projector. In such a case, points, which correspond to the respective points of the projection target object included in the display region, on the display surface of the projector 12 are discretely distributed. Thus, according to another modification example, the display region calculation unit 23 may interpolate the display region by obtaining coordinates of each point of the projection target object on the display surface of the projector 12 and then executing Morphological expansion and contraction operations on the display region a predetermined number of times (once or twice, for example).

The projection control unit 24 according to the second embodiment may set the value of the pixels in the display region on the display surface of the projector 12 to a predetermined value set in advance or a value obtained by Equation (5) or (6) in the same manner as in the first embodiment. Alternatively, the projection control unit 24 may set the value of pixels in the display region on the display surface of the projector 12 in accordance with the following equation.

R=Val (12)

G=Val

B=Val

Val=α×(Z_{W}−Z_{aveW})+β

A=300−(Z_{aveW}−Z_{surfaceW})×0.7

where A=0 when A<0, and A=255 when A>255.

Here, R, G, and B are values of a red component, a green component, and a blue component of pixels, respectively. A is an alpha value representing transparency. Z_{W} represents the height of a point of the projection target object corresponding to the pixel to the surface of the work platform in the world coordinate system. Z_{aveW} represents an average value of the height of each point of the projection target object, which is present within a predetermined range (150 mm, for example) along the Yw axis direction from the tip end of the object region in the Yw axis direction, namely the tip end of the projection target object, from the surface of the work platform in the world coordinate system. Z_{surfaceW} represents a height of the projection surface (the surface of the operation target object, for example) at an average value in the Xw axis direction and an average value in the Yw axis direction of each point in the objection region within a predetermined range (150 mm, for example) along the Yw axis direction from the tip end of the object region in the Yw axis direction. α and β are fixed values, and are set such that α=1.2 and β=128, for example. In such a case, the camera 15 may be omitted. The positioning unit 26 may convert the coordinates of each point of the projection target object into coordinates in the projector coordinate system or the depth sensor coordinate system instead of coordinates in the camera coordinate system in Steps S201 and S203. In doing so, the shape of the image of the projection target object is represented with contrasting density, and the height of the projection target object from the projection surface is represented with transparency. Furthermore, β of R, G, and B in Equation (12) may be a red component value, a green component value, and a blue component value, which correspond to the pixel, of a corresponding pixel on the image obtained by the camera 15. In such a case, the projection control unit 24 changes brightness of the image of the projection target object in accordance with the height from the projection surface to the projection target object while maintaining information of the color of the projection target object in the image of the projection target object.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus using a projector that includes a display surface and projects an image on a projection surface by displaying the image on the display surface, the apparatus comprising:
a memory; and
a processor coupled to the memory and configured to:
detect an object region where a target object is captured in a depth image obtained by a depth sensor, a value of each pixel in the depth image representing a distance between the target object and the depth sensor,
calculate a position of the target object, which is captured at each pixel corresponding to the target object in the object region, in a real space,
shift the calculated position of the target object in the real space to a position on the projection surface,
calculate a display region on the display surface of the projector corresponding to the target object by calculating a position on the display surface of the projector corresponding to the shifted position, and
display an image of the target object in the display region on the display surface of the projector.

2. The apparatus according to claim 1, wherein the processor is configured to:
change the image of the target object displayed on the display surface of the projector in accordance with a height from the projection surface to the target object at the time of capturing the depth image.

3. The apparatus according to claim 2, wherein the processor is configured to:
change at least one of a color, luminance, and transparency of the image of the target object displayed on the display surface of the projector in accordance with the height.

4. The apparatus according to claim 2, wherein the processor is configured to:
change a size of an outline of the image of the target object displayed on the display surface of the projector in accordance with the height.

5. The apparatus according to claim 1, wherein the processor is configured to:
detect a first position of a predetermined object at the time of capturing the image of the target object and a second position of the predetermined object at the time of projecting the image of the target object,
determine a position of the image of the target object on the projection surface in accordance with a positional relationship between the first position and the target object at the time of capturing the image of the target object and the second position, and
determine the display region on the display surface of the projector in accordance with a position of the image of the target object on the projection surface.

6. The apparatus according to claim 5, wherein the processor is configured to:
determine the position of the image of the target object on the projection surface such that the positional relationship between the first position and the target object is the same as a positional relationship between the second position and the image of the target object on the projection surface.

7. The apparatus according to claim 5, wherein the processor is configured to:
set, as the position of the image of the target object on the projection surface, a position shifted from a position, which is moved from the second position by a position shift amount of the target object with respect to the first position, by a predetermined offset amount.

8. The apparatus according to claim 1, wherein the processor is configured to:
set the pixel value of each pixel in the display region to a corresponding pixel value on the image of the target object captured by a camera at the time of capturing the image.

9. A method of projecting using a projector that includes a display surface and projects an image on a projection surface by displaying the image on the display surface, the method comprising:
detecting an object region where a target object is captured in a depth image obtained by a depth sensor, a value of each pixel in the depth image representing a distance between the target object and the depth sensor;
calculating a position of the target object, which is captured at each pixel corresponding to the target object in the object region, in a real space;
shifting the calculated position of the target object in the real space to a position on the projection surface;
calculating, by a processor, a display region on the display surface of the projector corresponding to the target object by calculating a position on the display surface of the projector corresponding to the shifted position; and
displaying an image of the target object in the display region on the display surface of the projector.

10. The method according to claim 9, further comprising:
changing the image of the target object displayed on the display surface of the projector in accordance with a height from the projection surface to the target object at the time of capturing the depth image.

11. The method according to claim 10, further comprising:
changing at least one of a color, luminance, and transparency of the image of the target object displayed on the display surface of the projector in accordance with the height.

12. The method according to claim 10, further comprising:
changing a size of an outline of the image of the target object displayed on the display surface of the projector in accordance with the height.

13. The method according to claim 9, further comprising:
detecting a first position of a predetermined object at the time of capturing the image of the target object and a second position of the predetermined object at the time of projecting the image of the target object;
determining a position of the image of the target object on the projection surface in accordance with a positional relationship between the first position and the target object at the time of capturing the image of the target object and the second position; and
determining the display region on the display surface of the projector in accordance with a position of the image of the target object on the projection surface.

14. The method according to claim 13, further comprising:
determining the position of the image of the target object on the projection surface such that the positional relationship between the first position and the target object is the same as a positional relationship between the second position and the image of the target object on the projection surface.

15. The method according to claim 13, further comprising:
setting, as the position of the image of the target object on the projection surface, a position shifted from a position, which is moved from the second position by a position shift amount of the target object with respect to the first position, by a predetermined offset amount.

16. The method according to claim 9, further comprising:
setting the pixel value of each pixel in the display region to a corresponding pixel value on the image of the target object captured by a camera at the time of capturing the image.

17. A non-transitory storage medium storing a program for causing a computer using a projector that includes a display surface and projects an image on a projection surface by displaying the image on the display surface to execute a process, the process comprising:
detecting an object region where a target object is captured in a depth image obtained by a depth sensor, a value of each pixel in the depth image representing a distance between the target object and the depth sensor;
calculating a position of the target object, which is captured at each pixel corresponding to the target object in the object region, in a real space;
shifting the calculated position of the target object in the real space to a position on the projection surface;
calculating a display region on the display surface of the projector corresponding to the target object by calculating a position on the display surface of the projector corresponding to the shifted position; and
displaying an image of the target object in the display region on the display surface of the projector.

18. The storage medium according to claim 17, wherein the process further comprises:
changing the image of the target object displayed on the display surface of the projector in accordance with a height from the projection surface to the target object at the time of capturing the depth image.

19. The storage medium according to claim 17, wherein the process further comprises:
detecting a first position of a predetermined object at the time of capturing the image of the target object and a second position of the predetermined object at the time of projecting the image of the target object;
determining a position of the image of the target object on the projection surface in accordance with a positional relationship between the first position and the target object at the time of capturing the image of the target object and the second position; and
determining the display region on the display surface of the projector in accordance with a position of the image of the target object on the projection surface.

20. The storage medium according to claim 17, wherein the process further comprises:
setting the pixel value of each pixel in the display region to a corresponding pixel value on the image of the target object captured by a camera at the time of capturing the image.
